(19) United States
(12) Patent Application Publication
(10) Pub. No.: US 2010/0195969 A1
(43) Pub. Date: Aug. 5, 2010

(54) MULTI-FIBER CABLE MANAGEMENT PANEL

(76) Inventors: BRYAN KENNEDY, NORCROSS, GA (US); CHAD ANDERSON, NEW PRAGUE, MN (US); TIMOTHY HAATAJA, PRIOR LAKE, MN (US)

Correspondence Address: MERCHANT & GOULD PC, P.O. BOX 2903, MINNEAPOLIS, MN, 55402-0903, US

(21) Appl. No.: 12/697,716

(22) Filed: Feb. 1, 2010

Related U.S. Application Data
(60) Provisional application No. 61/149,234, filed on Feb. 2, 2009.

(51) Int. Cl. G02B 6/00

(52) U.S. Cl. 385/135

(57) ABSTRACT

A multi-fiber fiber panel includes side entrances for multi-fiber jumper cables, and front exits for individual fiber cables. Disposed within an interior of the panel are multi-fiber adapters for connecting the multi-fiber jumper cables to multi-fiber breakout cables. The breakouts are positioned within an interior of the panel. A slideable tray contains the multi-fiber adapters and multi-fiber connectors within the panel. Cable entrances and cable exits remain stationary as the tray is moved. MPO connectors are used.

### CROSS-REFERENCE TO RELATED APPLICATIONS

The present application claims priority to U.S. Provisional Patent Application No. 61/149,234, filed Feb. 2, 2009, the disclosure of which is hereby incorporated by reference in its entirety.

### FIELD OF THE INVENTION

This disclosure relates to devices for use in the telecommunications industry, and associated methods. More specifically, this disclosure relates to a cable management panel for use with multi-fiber cables and breakouts.

### BACKGROUND OF THE INVENTION

Many local area networks and telecommunication systems utilize panels and other structures to manage cables extending between telecommunications equipment. Demand for greater telecommunications services has prompted the increase in circuit densities of the systems. Multi-fiber optical cables and connectors are known for increasing density. MPO-type is one multi-fiber connector type know in the industry. Notwithstanding the advances made in the art, there is a continuous need for further advances to improve upon high density systems and associated methods. Improvements are needed, for example, to enhance cable access and cable management associated with installation, maintenance, repair, upgrade, and cross-connection procedures related to equipment.

### SUMMARY OF THE INVENTION

The present disclosure relates to a panel having an entrance for multi-fiber cables and an interior for providing termination of the multi-fiber cables with multi-fiber cables having breakouts. The interior of the panel manages slack and the breakouts of the multi-fiber cables into a plurality of individual fibers. The panel includes exits for the individual fibers extending from the breakouts. In one embodiment, the multi-fiber cables enter at a side of the panel and the individual breakout fibers exit from a front of the panel.

In one exemplary system, multi-fiber jumper cables extend from equipment to the panel. At multi-fiber adapter locations within the panel, multi-fiber cables, each with a breakout, connect to the multi-fiber jumper cables. The individual fibers from the breakouts connect to equipment mounted below the panel. A variety of examples of desirable product features or methods are set forth in part in the description that follows, and in part will be apparent from the description, or may be learned by practicing various aspects of the disclosure. The aspects of the disclosure may relate to individual features as well as combinations of features. It is to be understood that both the foregoing general description and the following detailed description are explanatory only, and are not restrictive of the claimed invention.

### BRIEF DESCRIPTION OF THE DRAWINGS

FIG. 1 is a front perspective view of one embodiment of a fiber panel, in accordance with the principles disclosed, shown with exemplary cables;

FIG. 2 is a front view of the fiber panel of FIG. 1;

FIG. 3 is a side view of the fiber panel of FIG. 1;

FIG. 4 is a top view of the fiber panel of FIG. 1;

FIG. 5 is a front perspective view of the fiber panel of FIG. 1, with a front top cover portion removed;

FIG. 6 is a top view of the fiber panel of FIG. 4 with the front top cover portion removed, and with a top panel structure of the chassis removed for viewing, and further showing exemplary cables;

FIG. 7 shows in perspective view the fiber panel of FIG. 6, with a tray in an open position;

FIG. 8 is a perspective view of an exemplary multi-fiber adapter;

FIG. 9 is a perspective view of an exemplary cable terminated by a multi-fiber connector;

FIG. 10 is a detail view of a cable radius limiter element used along the front and the sides of the fiber panel of FIGS. 1-7;

FIG. 11 shows the radius limiter of FIG. 10 in a cable access position;

FIG. 12 is a schematic side view of a telecommunications system including the fiber panel of FIGS. 1-7;

FIG. 13 is a front perspective view of another embodiment of a fiber panel, in accordance with the principals disclosed;

FIG. 14 is a front perspective view of the fiber panel of FIG. 13, with a front top cover portion removed;

FIG. 15 shows in perspective view the fiber panel of FIGS. 13 and 14, with a tray in an open position;

FIG. 16 is a top view of the fiber panel of FIG. 15, with the tray in a closed position;

FIG. 17 is a top view like FIG. 16, showing exemplary cables; and

FIG. 18 is a perspective view like the view of FIG. 15, and further showing exemplary cables.

### DETAILED DESCRIPTION OF THE PREFERRED EMBODIMENTS

Reference will now be made in detail to exemplary aspects of the present disclosure that are illustrated in the accompanying drawings. Whenever possible, the same reference numbers will be used throughout the drawings to refer to the same or like parts.

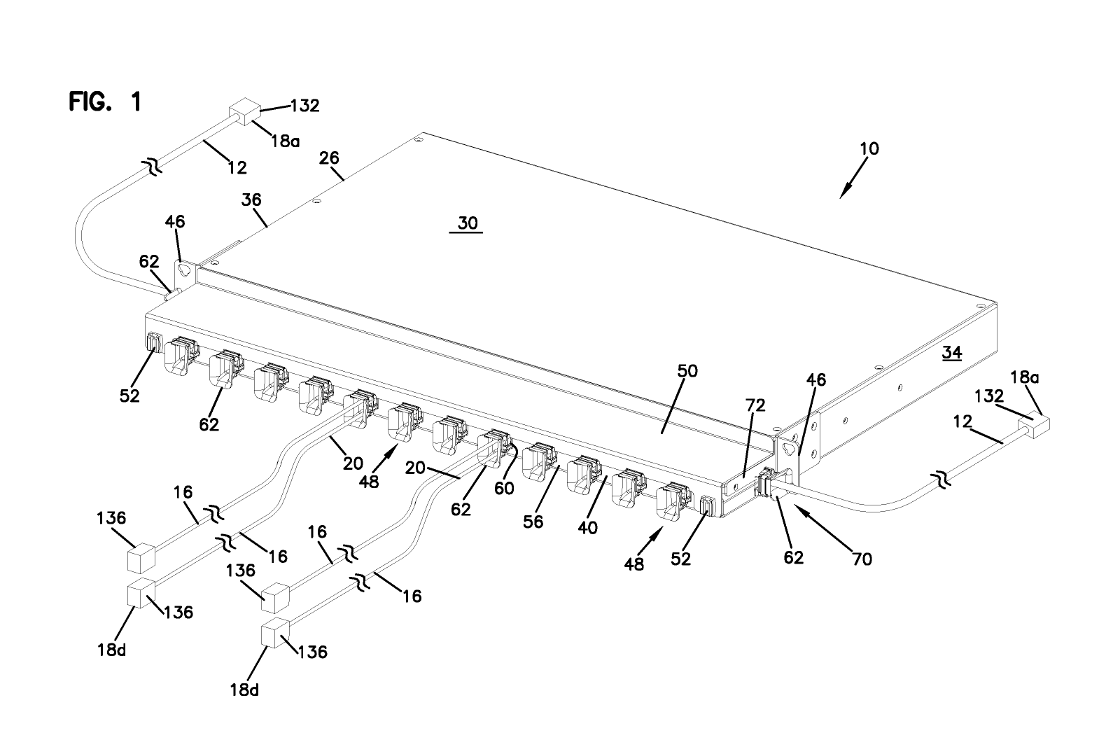

FIG. 1 illustrates a fiber panel 10 in accordance with the principles disclosed. The panel 10 is designed to provide a cable management location for fiber optic cables. In one embodiment multi-fiber cables are managed by panel 10. In the illustrated embodiment, multi-fiber cables 12 enter panel 10 and are broken out into individual single-fiber cables 16 as will be described in greater detail below.

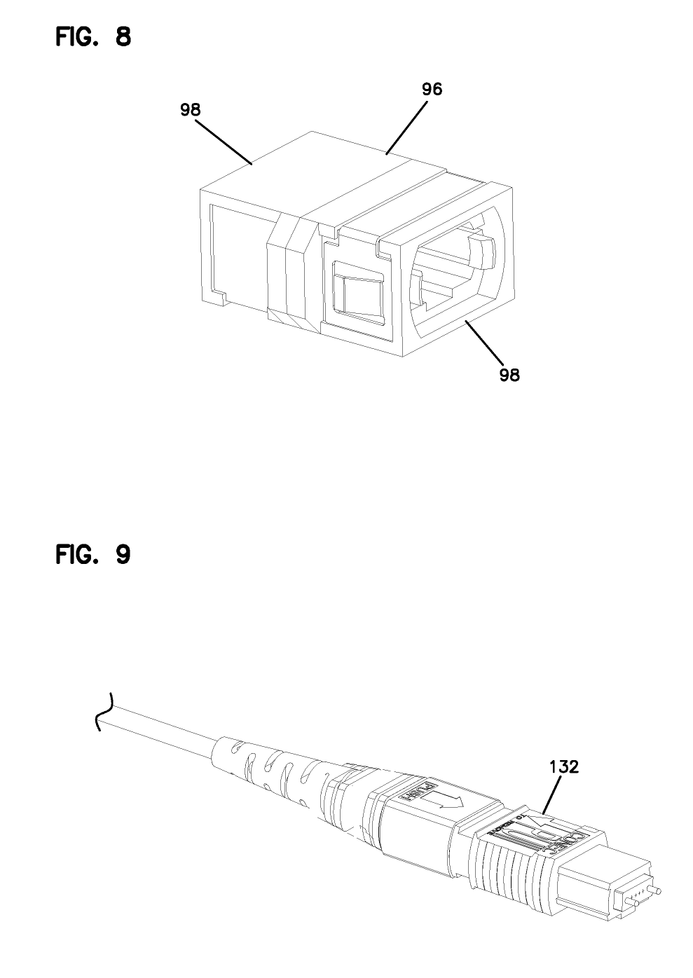

Multi-fiber cables include multiple fibers within an outer jacket. Multi-fiber connectors and adapters are known for connecting ends of multi-fiber cables without splicing. MPO-type and MTP-type connectors and adapters are known (see FIGS. 8 and 9).

Panel 10 allows for a multi-fiber cable with at least one multi-fiber connectorized end to be connected to a second multi-fiber cable with a multi-fiber connectorized end at one end and a cable breakout with individual fibers or cables on the opposite end. In one preferred implementation, panel 10 contains within an interior the multi-fiber connections and the cable breakouts so that only the individual fibers extend out to equipment, preferably located below the panel and preferably without needing extra cable slack and slack management between the panel and the equipment.

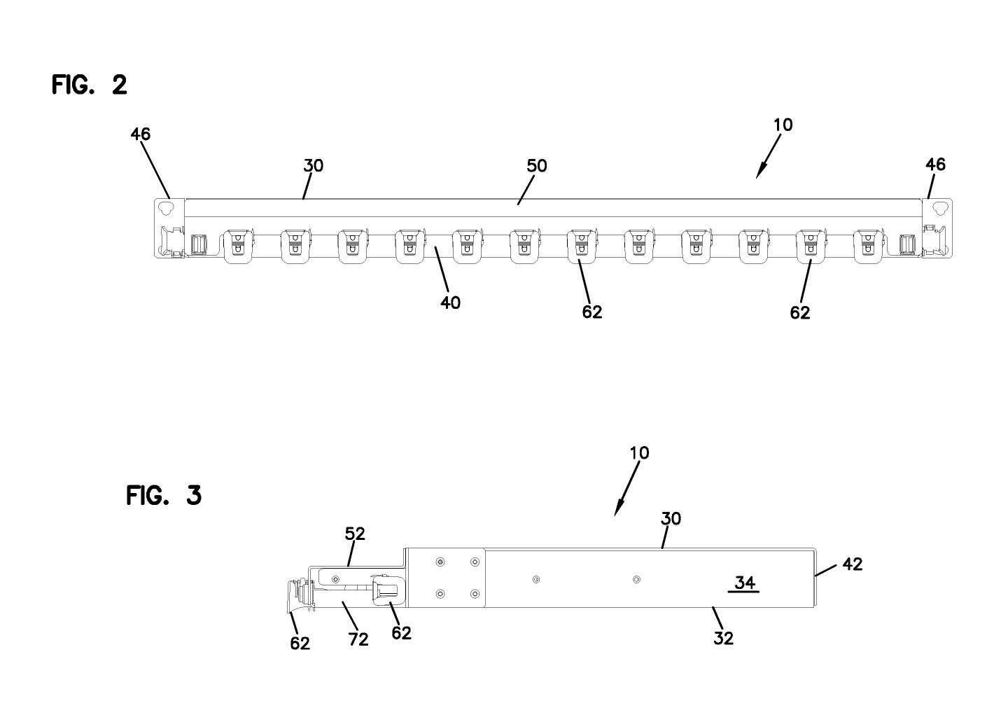

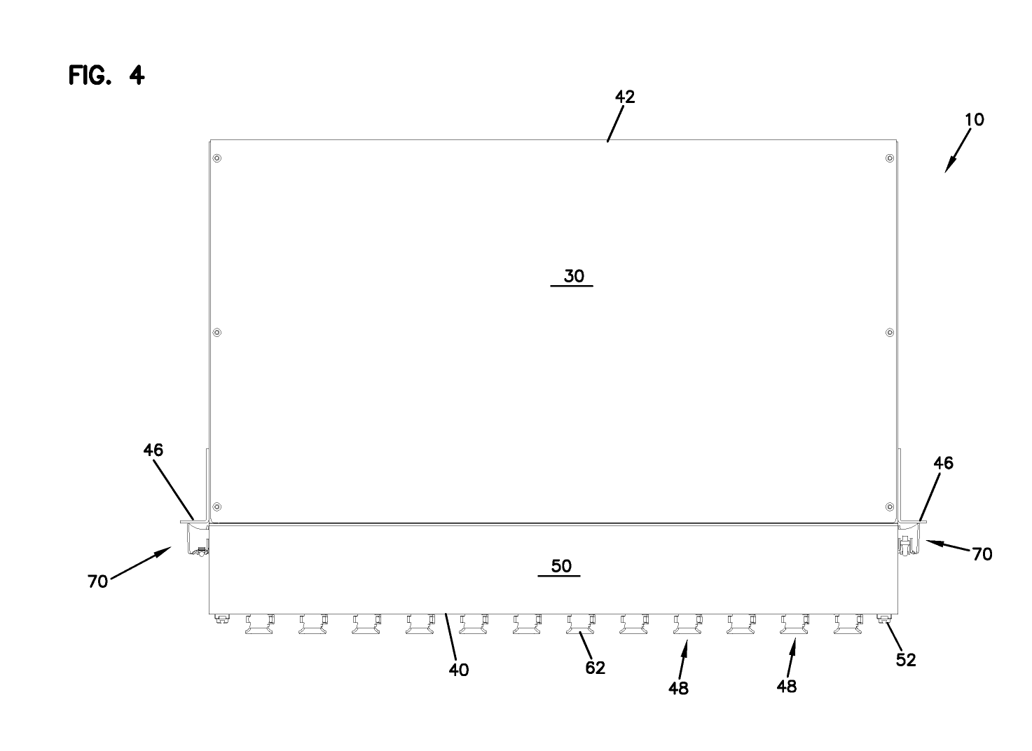

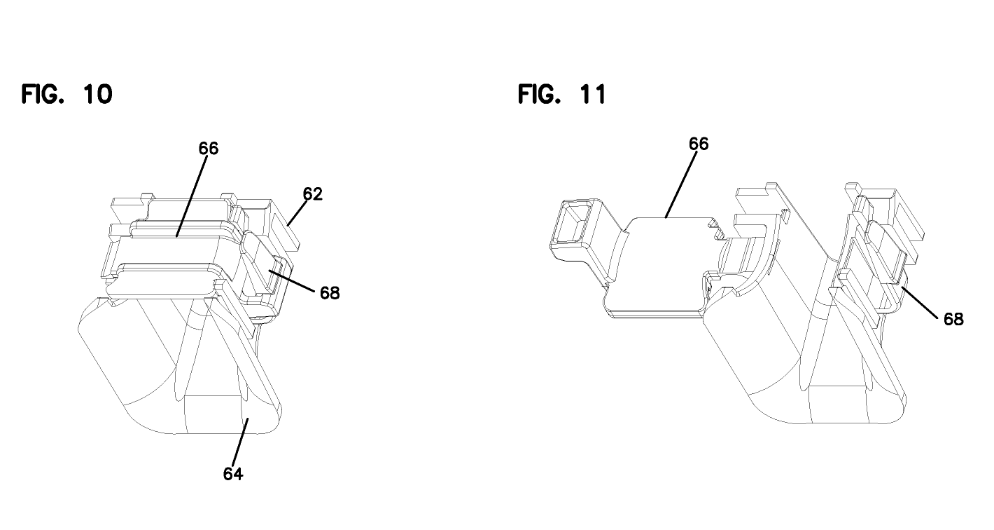

In the illustrated embodiment of FIGS. 1-11, cable 12 is shown as a jumper cable with opposite ends 18a, 18b terminated by multi-fiber connectors 132, such as MPO connectors. Cables 16 are part of a separate breakout cable 20 which is connected to jumper cable 12 within panel 10. Breakout cable 20 includes a connector 132 at one end 18c inside panel 10, and single fiber connectors 136, such as SC, LC or LX.5 (by ADC Telecommunications) at opposite ends 18d of cables 16.

Panel 10 includes a chassis 26 including a top 30, a bottom 32, a right side 34, and a left side 36. Chassis 26 further includes a front 40 and a back 42. Chassis 26 defines an enclosed structure with an interior 44. Chassis 26 is preferably made from sheet metal. Brackets 46 mount panel 10 to a rack or other mounting structure.

In the illustrated embodiment, panel 10 is one rack unit (1 RU) tall between top 30 and bottom 32. A 1 RU is typically 1.75 inches long. Other heights can be selected, including multiples of 1 RU, or other heights.

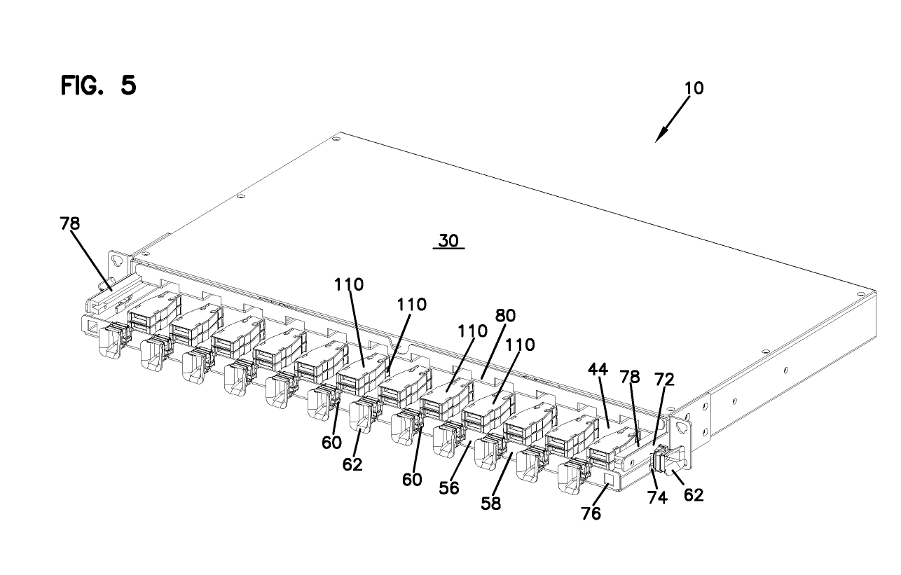

Top 30 of panel 10 includes a top cover portion 50 adjacent to front 40. Latches 52 cooperate with a remainder of panel 10 to secure top cover portion 50 in place. Latches 52 are released to allow removal of top cover portion 50 (see FIG. 5). Removing top cover portion 50 allows access by a technician to interior 44. Removing top cover portion 50 also creates an open front to allow features of panel 10 to be moved outside of interior 44.

Along a front portion 56 of panel 10 opposite to top cover portion 50 are exit locations 48 for the individual fibers or cables 16 to exit panel 10. Front portion 56 includes a front lip 58 including spaced apart slots 60. A radius limiter 62 is positioned in each slot 60. Radius limiter 62 includes a flared trumpet shape 64 for bend radius protection of the fibers. Radius limiter 62 includes a hinged panel 66 and a clip 68 for releasably holding hinged panel 66 closed. Hinged panel 66 allows for cables to be removed or added to the protected interior area of radius limiter 62. Each radius limiter holds a group of fibers, such as a group common to a breakout within panel 10. Lip 58 also includes two apertures 76 for cooperating with latches 52 to mount top cover portion 50 to front portion 56.

Side portion 72 on each side 34, 36 of panel 10 allows for a cable entry location 70 into panel 10. Each side portion 72 includes an opening 74 and a radius limiter 62 positioned therein. In this manner, the multi-fiber cables entering panel 10 through side portions 72 are segregated from the broken out individual fibers passing through front 40.

Each radius limiter 62 allows the cable to be directed 90° relative to panel 10 without allowing sharp bends of the cable on the sheet metal edges of panel 10. Due to the closed shape of radius limiter 62, cables will not fall out.

Disposed within interior 44 of panel 10 along right and left sides 34, 36 are longitudinal guides 78 which allow forward and backward sliding movement of a tray 80 into and out of interior 44 once top cover portion 50 is removed. Tray 80 includes a front lip 82 with a front finger slot 84 for convenient grasping by the technician to move tray 80 into and out of interior 44. Tray 80 defines side edges 86 which fit within longitudinal guides 78 to permit the sliding movement of tray 80.

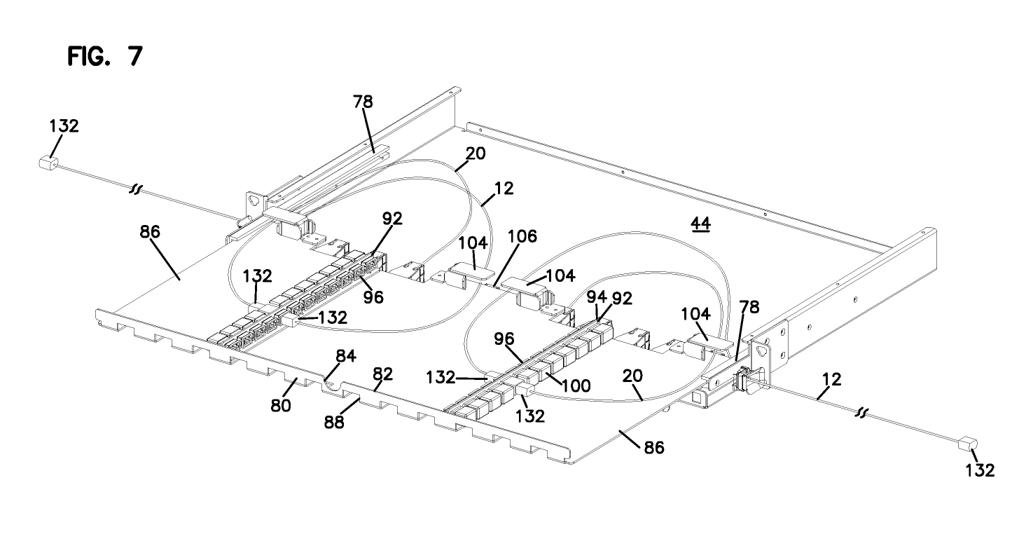

Tray 80 also defines a plurality of termination locations 90 on an interior region 88 of tray 80. In the illustrated embodiment, termination locations 90 include a panel structure 92 with a plurality of apertures 94, each sized for receiving an adapter 96. In the illustrated embodiment, each adapter 96 is an adapter with opposite ends 98 each for receiving a connector 132 in alignment. As shown in FIG. 7, ends 98 of adapters 96 which face outwardly are shown with dust caps 100. Tray 80 further includes cable managers 104 adjacent a back edge 106 for managing cables extending across back edge 106.

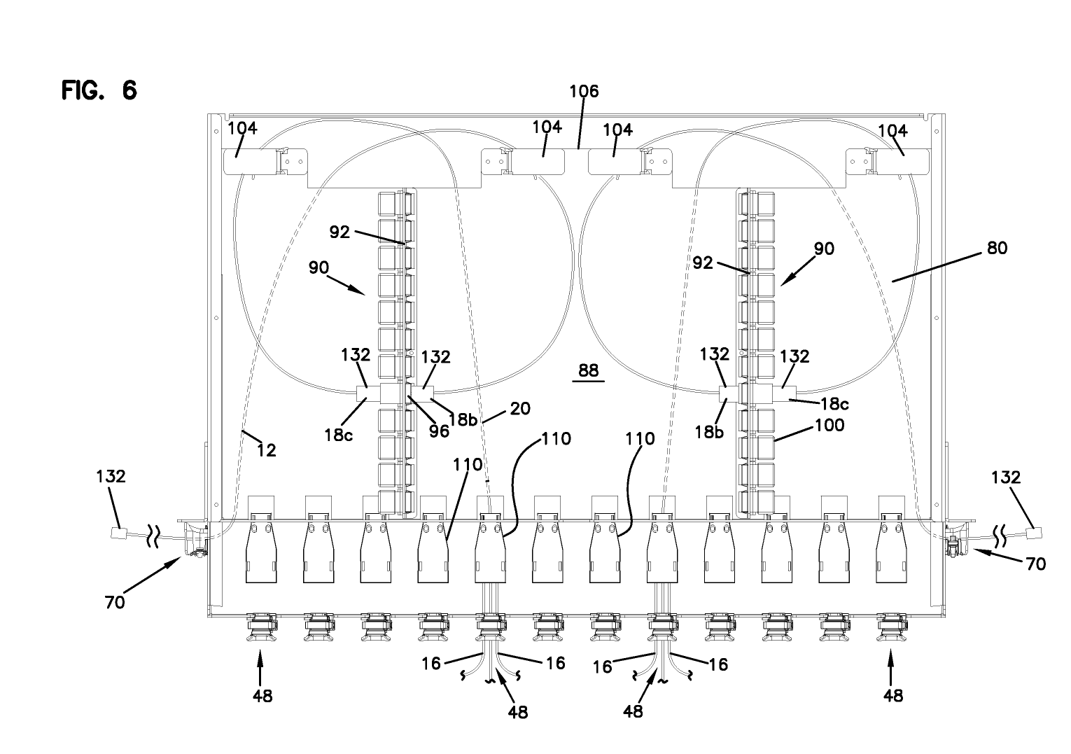

Tray 80 defines a space within interior 44 of panel 10 for managing the cable connections between cables 12 and 20. The space on tray 80 for the connections is in an upper area of panel 10. An area under tray 80 is a lower level which houses various cable breakouts 110 where multi-fiber cables are broken out into individual cables. The cable breakouts 110 are shown stacked two high. The stacked breakouts are in axial alignment with exits 48 (See FIG. 6). In use, multi-fiber cables enter openings 74 in side portions 72 of panel 10. The cable breakouts 110 are fixed (by clamp, holder, latch) within interior 44 along bottom 32 and are positioned so that cables exit along front 40 of panel 10. Notches 88 in tray 80 provide for extra clearance above cable breakouts 110.

Jumper cables 12 enter panel at one of entry locations 70 along the sides 34, 36. The cable 12 passes under tray 80 and around back edge 106 to area 88 on top of tray 80. A connector 132 on an end of cable 12 connects to an adapter 96. On an opposite end of adapter 96, a connector 132 of breakout cable 20 connects to adapter 96. Cable 20 then passes along the top of tray 80 and around the back edge 106, and then under tray 80 to one of the breakouts 110, then out of panel 10 at one of the exit locations 48 as individual fibers 16.

In use of panel 10, jumper cables 12 extend from telecommunications equipment and enter panel 10. Jumper cables 12 can be manufactured to standard lengths. Panel 10 connects those jumper cables 12 to breakouts and manages the breakouts so that individual fibers exit panel 10. As shown, breakout cables 20 are connected to the jumper cables 12 on tray 80 with adapters 96. Individual fibers 16 extend out from the breakouts 110 within the panel out the panel at exit locations 48. In one implementation, the cables extend downward directly to equipment located below panel 10. In this manner, the breakout cables 16 can be of shorter lengths and more easily custom-sized for use in the particular vertical space, while the longer jumper cables 12 can be more standardized. Variations in the length of cables 16 and the number per breakout can be manufactured as desired.

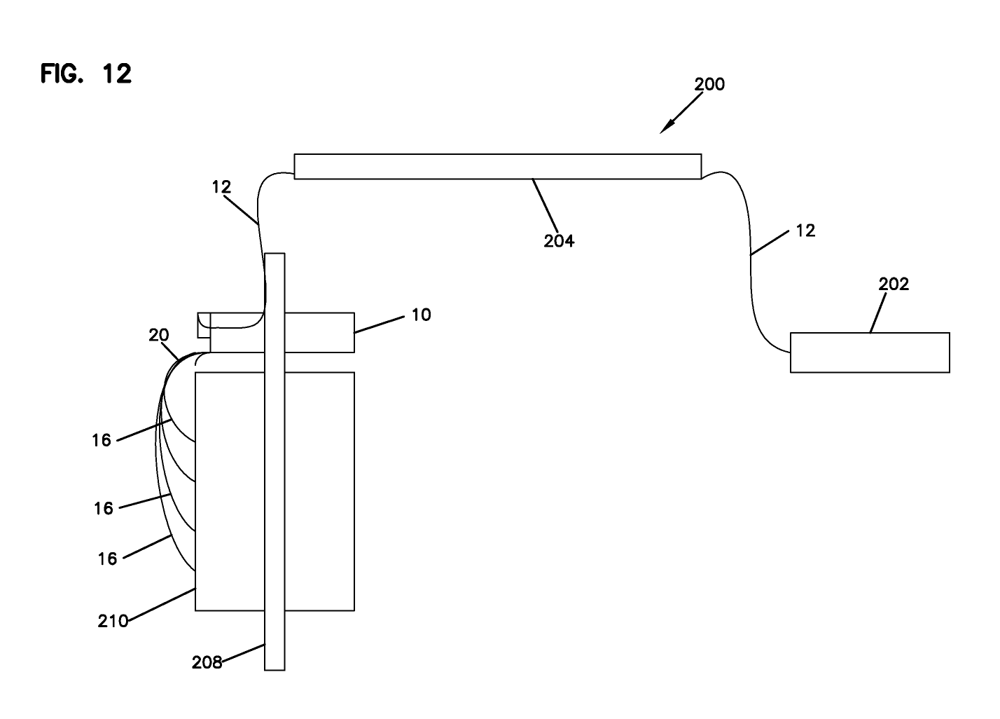

FIG. 12 shows an example system 200. Panel 10 is mounted to rack 208. Below panel 10 is network equipment 210, such as active network equipment. In some cases, these are vertical line cards with high numbers of connections. Jumper cables 12 extend from equipment 202, such as a cross-connect frame, to panel 10. Fiber trough system 204 may transport the cable across horizontal distances. At panel 10, the breakout cables 20 connect to the jumper cables 12. The individual fibers 16 exit panel 10 and extend down to network equipment 210 with front connection locations.

Tray 80 is moveable into and out of chassis 26 without moving entry locations 70 or exit locations 48. Only the termination locations 90 and the mated connectors 132 and adapters 96 in the illustrated embodiment move along with some internal cable slack. Slack storage for breakout single-fiber cables 16 is not needed since the cables drop straight down to the network equipment 210. These lengths can be customized for the particular network equipment 210. The same panel 10 can be used in other systems 200 where the lengths of the single-fiber cables 16, and the number per breakout 110, are different.

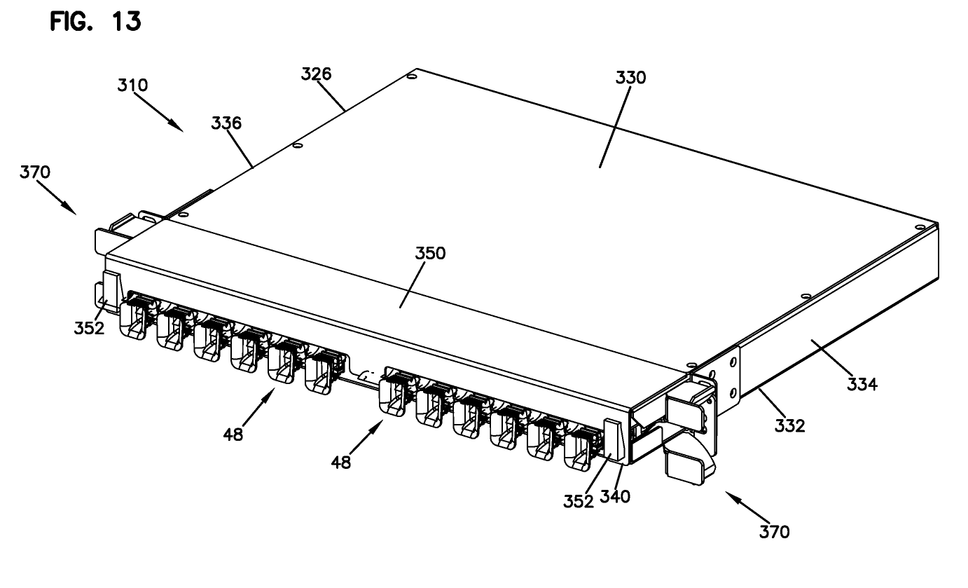

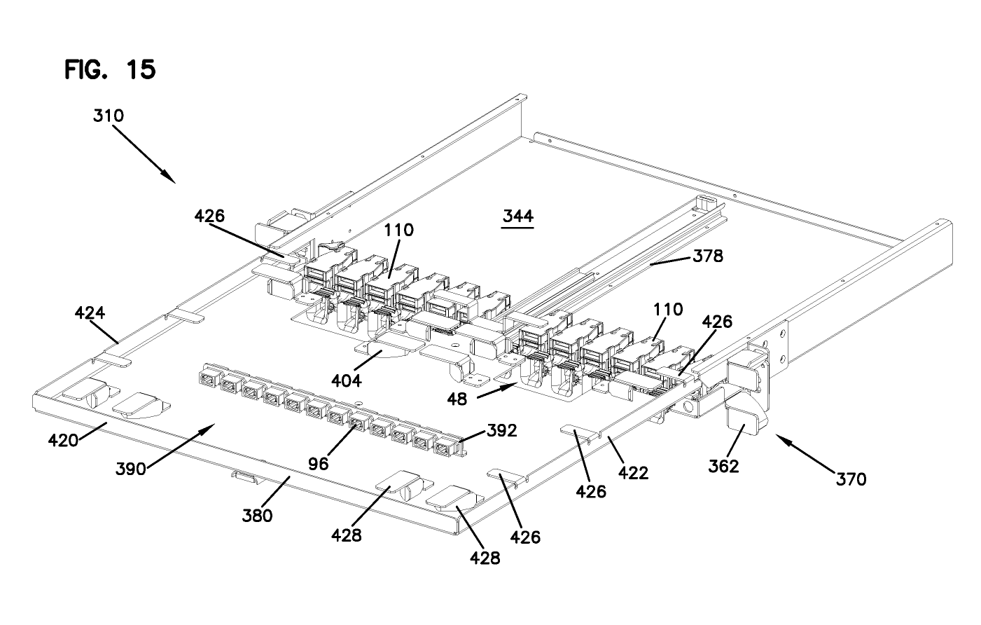

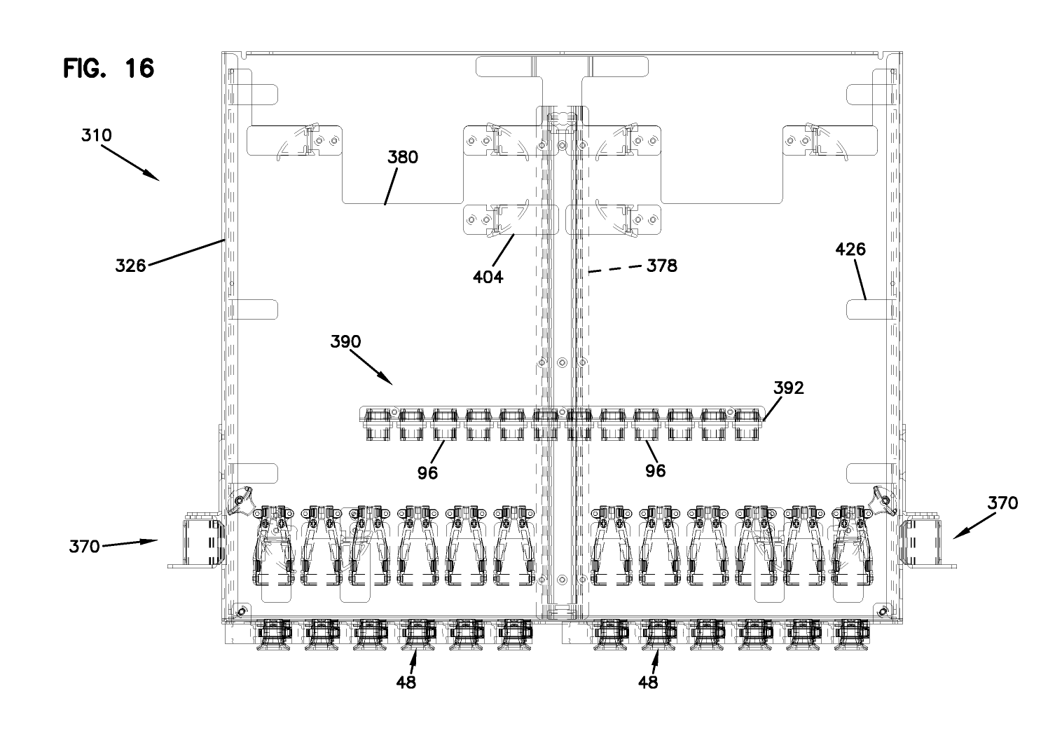

Referring now to FIGS. 13-18, a second embodiment of a fiber panel 310 in accordance with the principals disclosed herein is illustrated. As with fiber panel 10, multi-fiber cables 12 enter panel 310 and are broken out into individual single-fiber cables 16. Panel 310 includes a chassis 326 including a top 330, a bottom 332, a right side 334, and a left side 336. Chassis 326 further includes a front 340 and a back 342. In many respects, panel 310 is similar to panel 10 in terms of construction and use.

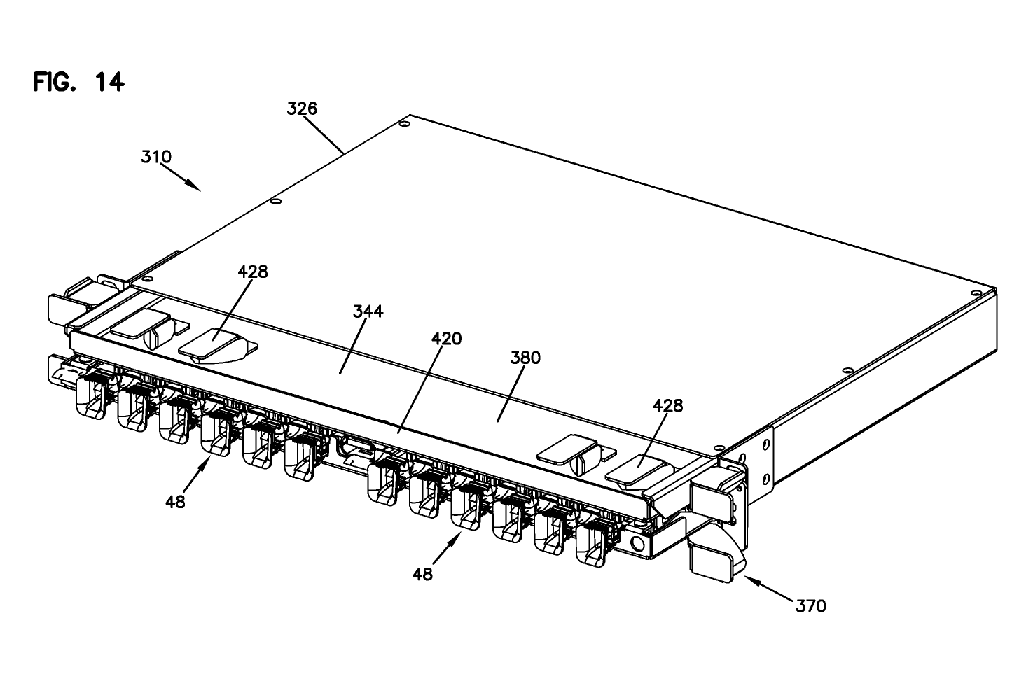

The top 330 of panel 310 includes a top cover portion 350 adjacent to front 340. Latches 352 cooperate with a reminder of panel 310 to secure top cover portion 350 in place. Latches 352 are released to allow removal of top cover portion 350 (see FIG. 14). Removing top cover portion 350 allows access by a technician to interior 344. Removing top cover portion 350 also creates an open front to allow features of panel 310 to be moved outside of interior 344.

Along front 340 of panel 10 are the exit locations 48 for the individual fibers or cables 16 to exit panel 310. Each side 334, 336 of panel 310 allows for a cable entry location 370 into panel 310. Cable entry location 370 includes a radius limiter 362 where cables can enter from below panel 310, or from above.

Panel 310 includes a longitudinal slide 378 which allows for sliding movement in a forward and backward direction of a tray 380. Tray defines a plurality of termination locations 390. In a similar manner as above with panel 10, termination locations 390 include a panel structure 392 for holding a plurality of adapters 96. Each adapter 96 has opposite ends, each one receiving a fiber connector in alignment. As illustrated in the embodiment of FIGS. 13-18, panel structure 392 extends in a direction between right and left sides 334, 336 of chassis 326. Tray 380 also includes a cable manager 404 for cables extending onto tray 380.

Tray 380 further includes a front lip 420, a right side lip 422, and a left side lip 424. Cable retention tabs 426 extend inwardly from top edges of right and left side lips 422, 424. Tray 380 further includes cable radius limiters 428 for managing cables located within tray 380.

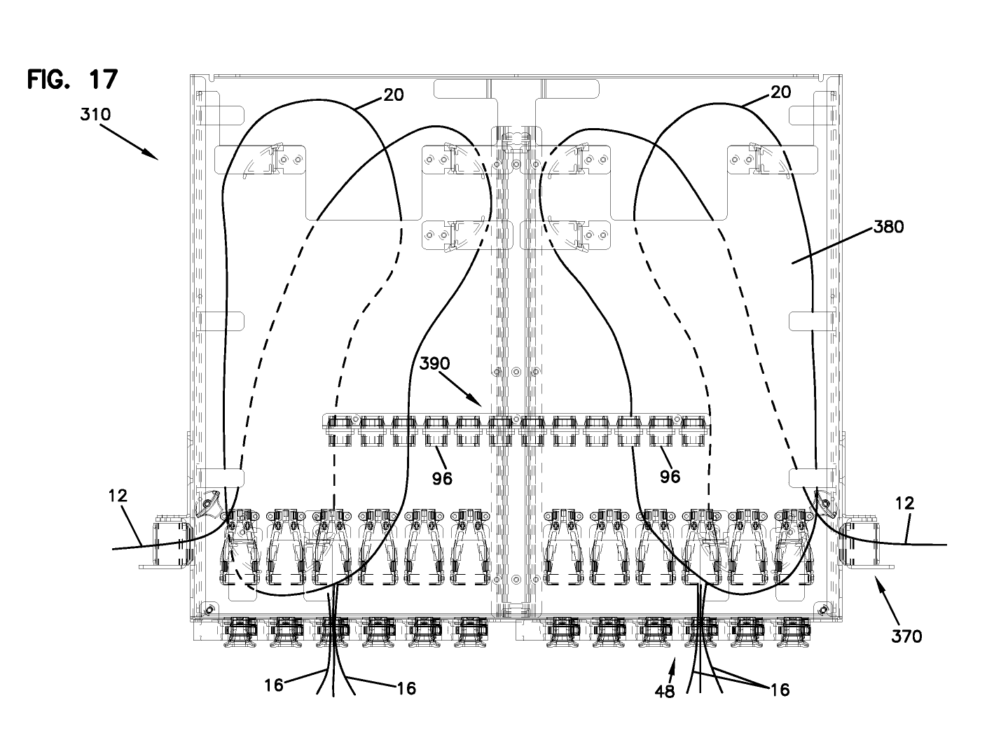

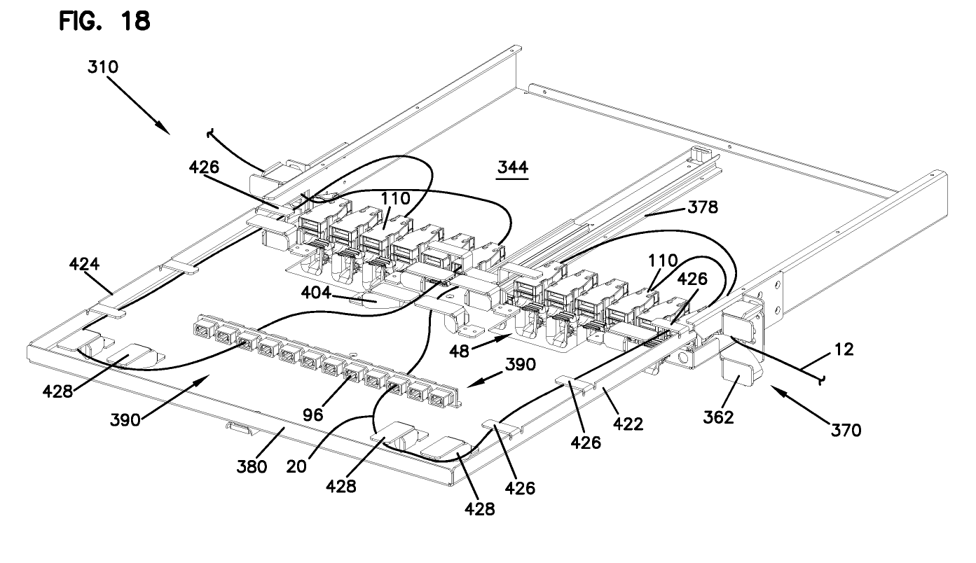

As shown in FIGS. 17 and 18, multi-fiber cables 12 enter panel 310 at cable entry locations 370 and pass below tray 380. Cables 12 then pass to a top of tray 380 through cable manager 404 to an adapter 96 at termination locations 390. From each adapter 96, the cables leave tray 380 and pass below tray 380 to a cable breakout 110. Then the single-fiber cables 16 exit panel 310 at one of exits locations 48.

As noted above for panel 10, tray 380 is moveable into and out of chassis 326 without moving entry locations 370 or exit locations 48. Only the termination locations 390 and the mated connectors and adapters move along with some internal cable slack. Slack storage for breakout single-fiber cables 16 is not needed since the cables drop straight down to telecommunications network equipment.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A fiber panel comprising:
a chassis including a top, a bottom, a front, a back, a right side, and a left side defining an interior, wherein the panel includes first and second side entrances for cables positioned along the right and left sides, respectively, wherein the panel includes a plurality of cable exits positioned along the front;
an interior divider positioned within the interior of the chassis between the top and bottom;
wherein an upper surface of the interior divider defines a plurality of multi-fiber adapter locations for connecting multi-fiber connectors together; and
wherein an area below the interior divider along the bottom defines a plurality of cable breakout locations, wherein the cable breakout locations are aligned with the front exits.

2. The fiber panel of claim 1, wherein the chassis is one rack unit long between the top and the bottom.

3. The fiber panel of claim 1, wherein the adapter locations are arranged in a line extending between the front and the back.

4. The fiber panel of claim 1, wherein the adapter locations are arranged in two lines extending between the front and the back.

5. The fiber panel of claim 1, wherein the adapter locations are arranged in a line extending between the right and left sides.

6. The fiber panel of claim 1, wherein the interior divider is slideable relative to the chassis relative to a front opening defined by the chassis between closed and open positions.

7. The fiber panel of claim 6, wherein the first and second side entrances and the plurality of cable exits are fixed from movement relative to the back of the chassis.

8. The fiber panel of claim 7, wherein the top of the chassis includes a removable top cover portion located adjacent to the front opening for providing selective access to the interior divider.

9. A fiber panel comprising:
a chassis including a top, a bottom, a front, a back, a right side, and a left side defining an interior, wherein the panel includes first and second side entrances for cables positioned along the right and left sides, respectively, wherein the panel includes a plurality of cable exits positioned along the front;
wherein a first area of the interior defines a plurality of multi-fiber adapter locations for connecting multi-fiber connectors;
wherein a second area of the interior defines a plurality of cable breakout locations, wherein the cable breakout locations are aligned with the front exits;
a plurality of multi-fiber cables passing through the side entrances;
a plurality of multi-fiber breakout cables extending through the front exits, the multi-fiber breakout cables each having a multi-fiber cable at one end, and individual broken out fibers at an opposite end, and a cable breakout in between;
wherein the multi-fiber jumper cables and the multi-fiber cables of the multi-fiber breakout cables are connected at the multi-fiber adapter locations, wherein the cable breakouts of the multi-fiber breakout cables are positioned within the interior of the panel.

10. The fiber panel of claim 9, wherein the first and second side entrances and the plurality of cable exits are not moveable relative to the back of the chassis.

11. The fiber panel of claim 9, wherein an interior divider between the first and second areas is slideable relative to the chassis relative to a front opening defined by the chassis between closed and open positions.

12. The fiber panel of claim 11, wherein the top of the chassis includes a removable top cover portion located adjacent to the front opening for providing selective access to the interior divider.

13. A telecommunications system comprising:
(a) a rack;
(b) a breakout management panel mounted to the rack including:
(1) a chassis including an interior, and a plurality of side entrances for cables entering the chassis; the chassis including a plurality of front exits for cables exiting the chassis;
(2) a plurality of multi-fiber adapters in the interior of the chassis;
(3) a plurality of breakout holders positioned in the interior of the chassis and aligned with the front exits;
(4) a cable radius limiter positioned at each front exit and defining a cable path extending vertically downwardly;
(5) wherein the side entrances and the side exits are stationarily fixed relative to the rack;
(c) a plurality of multi-fiber cables passing through the side entrances;
(d) a plurality of multi-fiber breakout cables extending through the front exits, the multi-fiber breakout cables each having a multi-fiber cable at one end, and individual broken out fibers at an opposite end, and a cable breakout in between;
(1) wherein the plurality of multi-fiber cables and the multi-fiber breakout cables are connected to each other at the plurality of multi-fiber adapters;
(2) wherein the cable breakouts are positioned in one of the breakout holders, wherein cable outputs from each cable breakout are aligned with one of the front exits;
(e) network equipment mounted to the rack below the breakout management panel;
(1) wherein the individual broken out fibers extend horizontally outward from the front exits and vertically downwardly;
(2) wherein the individual broken out fibers connect to the network equipment;
(3) wherein the individual broken out fibers extend directly to the network equipment from the breakout management panel without any slack.

14. A method of managing fibers comprising the steps of:
providing a cable management panel including a top, a bottom, a front, a back, a right side, and a left side;
extending a plurality of multi-fiber jumper cables to the panel wherein the multi-fiber jumper cables pass through side entrances into the panel;
connecting a multi-fiber connector on each of the multi-fiber jumper cables to a multi-fiber adapter located inside of the panel;
connecting a multi-fiber breakout cable to each of the multi-fiber adapters to connect the multi-fiber connectors of the multi-fiber jumper cables within the interior of the panel;
mounting cable breakouts of the multi-fiber breakout cables within an interior of the panel; and
exiting individual fiber cables at the front of the panel.
